(19) United States
(12) Patent Application Publication
(10) Pub. No.: US 2014/0086443 A1
(43) Pub. Date: Mar. 27, 2014

(54) Microphone Systems for Base Drums and Other Instruments

(71) Applicant: Terrance Marshall Morton, San Rafael, CA (US)

(72) Inventor: Terrance Marshall Morton, San Rafael, CA (US)

(21) Appl. No.: 13/844,694

(22) Filed: Mar. 15, 2013

Related U.S. Application Data
(60) Provisional application No. 61/705,974, filed on Sep. 26, 2012.

(51) Int. Cl. H04R 1/02

(52) U.S. Cl. CPC H04R 1/02
USPC 381/361

(57) ABSTRACT

A microphone system and microphone mount system integrate upon and into a drum head to efficiently capture various drum sounds. An attachment ring 170 is attached to the perimeter of a void within a drum head. A slide bracket slides 160 into the attachment ring 170. The slide bracket 160 is secured to and is part of a microphone assembly 100. The microphone assembly accommodates flexible goose necks 200 that hold microphone clip adapters to secure additional microphones both interior and exterior to a drum head 300.

### RELATED PATENT APPLICATION AND INCORPORATION BY REFERENCE

This is a utility application based upon U.S. patent application Ser. No. 61/705,974 filed on Sep. 26, 2012. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

(1) Field of the Invention

The invention generally relates to microphone systems. More particularly, the invention relates to systems and methods of improved sound capture within and near a drum or other instrument.

(2) Description of the Related Art

U.S. Pat. No. 7,525,039 by Steele discloses an electronic bass drum comprising loud speakers, an internal amplifier system and other components. U.S. Pat. No. 7,723,596 by Kelly discloses an internal microphone support system allowing a standard microphone to be placed within a drum. Kelly uses a plurality of hanger members and connector members. U.S. Pat. No. 7.968,780 by Millender et al discloses an insert for a double membrane drum in an effort to change the tonal qualities of the drum. U.S. Pat. No. 8,170,258 by Wells discloses a support bar system placed within a drum to support a microphone.

The prior art presents several shortfalls in that complicated and cumbersome components are used to alter the sound of a drum or to secure a microphone within a drum. Such prior art solutions are not well suited for the rigors of road tours or for drummers of limited means. The prior art solutions also fail to capture the true tonal qualities generated by high end drums. Thus, there is a need in the art for the presently disclosed embodiments.

### BRIEF SUMMARY OF THE INVENTION

The present invention overcomes shortfalls in the related art by presenting an unobvious and unique combination, configuration and use of mounting and microphone components to efficiently capture drum sound found within a drum and outside of a drum.

Disclosed embodiments use a compact microphone assembly that easily attaches to an attachment ring. The attachment ring is secured at the perimeter of a circular void found upon a drum head or resonant membrane. With the advent of various new port systems, circular voids within drum heads are becoming more common in the percussion field; however, the prior art fails to leverage such voids to improve microphone performance or to artfully secure microphones.

Disclosed embodiments achieve unexpectedly excellent results in capturing smooth frequency responses as compared to the prior art. For example, disclosed embodiments achieve remarkable results in capturing sound in the range of 47 Hz, as shown in FIG. 13 below. Disclosed microphone assemblies use an artful combination of components which comprise hemp cones, speaker covers with voids, neodymium magnets, foam spacers, slide brackets, and O rings and foam rings attached to attachment rings.

Disclosed embodiments overcome the shortfalls in the art by providing efficient, artful and integrated goose necks to secure additional microphones near a beater or other implement striking a drum head and to secure additional microphones within a drum enclosure. Unlike the prior art, disclosed microphone attachment systems do not add bulk to a drum kit.

### BRIEF DESCRIPTION OF THE DRAWINGS

FIG. 1 depicts a perspective view of a microphone assembly

FIG. 2 depicts a front view of a microphone assembly

FIG. 3 depicts a rear view of a microphone assembly

FIG. 4 depicts components of a microphone assembly

FIG. 5 depicts components of a microphone assembly in an exploded view

FIG. 6 depicts components of a microphone assembly and a drum

FIG. 7 depicts a microphone assembly and a drum

FIG. 8 depicts a front side of a slide bracket

FIG. 9 depicts a section view of a slide bracket with a microphone goose neck

FIG. 10 depicts an exploded view of a slide bracket with a microphone goose neck

FIG. 11 depicts a sectional view of a slide ring and attachment ring

FIG. 12 depicts a front view of a slide ring with a microphone goose

FIG. 13 depicts a back view of an slide ring with a microphone goose

FIG. 14 depicts a frequency response chart

FIG. 15 depicts a frequency response chart of a prior art device

FIG. 16 depicts a microphone system of the prior art

FIG. 17 depicts a drum insert of the prior art

FIG. 18 depicts an internal microphone system of the prior art

FIG. 19 depicts an internal microphone support system of the prior art

FIG. 20 depicts an electric bass drum system of the prior art

FIG. 21 depicts an expanded sectional view a slide bracket and attachment ring

### REFERENCE NUMERALS IN THE DRAWINGS

100 a microphone assembly

110 speaker cover

112 voids in speaker cover 110

115 XLR jack location

120 speaker frame

125 speaker voice coil and spider area

130 magnet, sometimes a neodymium magnet

140 speaker cone, sometimes a hemp cone

150 foam spacer, with optional closed cells

155 mesh screen

160 slide bracket

161 shelf of slide bracket

162 channel for XLR cable

163 attachment voids of slide bracket

164 void within slide bracket, void used for goose neck attachment

165 inner circumference of slide bracket

166 outer circumference of slide bracket

167 containment pocket of slide bracket

170 attachment ring

172 foam member of attachment ring, with optional closed cells

173 drum head O ring

174 insertion portion of attachment ring

175 inner wall of attachment ring

176 top side of foam member 174, the top side sometimes attached to a drum head

200 flexible goose neck

210 microphone clip adapter female to male

220 microphone clip adapter male to male

300 drum head or resonant membrane

310 void of drum head

400 inner pocket floor of slide bracket

401 vertical outer wall is slide bracket

402 top wall of slide bracket

403 top face of slide bracket

404 inner floor of containment pocket 167

500 a smooth frequency response in the area of 47 Hz obtained with the disclosed embodiments

600 an uneven frequency response in the area of 47 Hz obtained with prior art methods

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

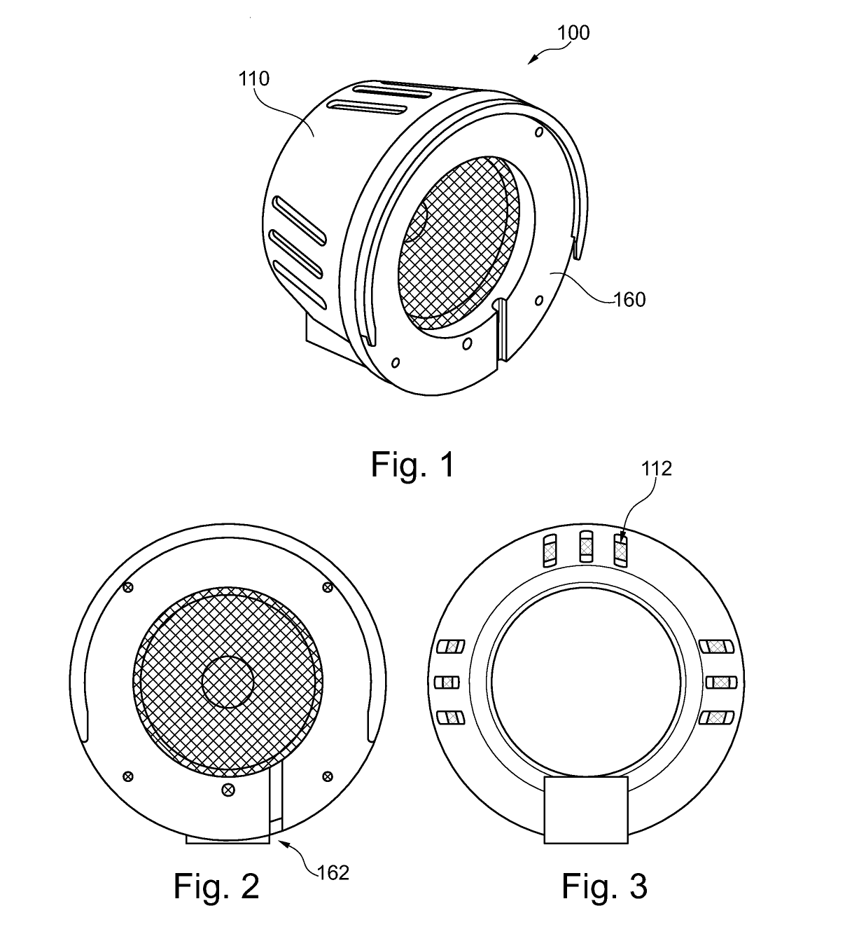

FIG. 1 depicts an assembled microphone assembly 100 in a front and side perspective view. A slide bracket is shown in the foreground and a speaker cover is shown in the background.

FIG. 2 depicts a top plan view of a microphone assembly 100. The slide bracket is shown with a channel 162 sometimes used with an XLR cable.

FIG. 3 is a back plan view, showing a speaker cover having voids 112.

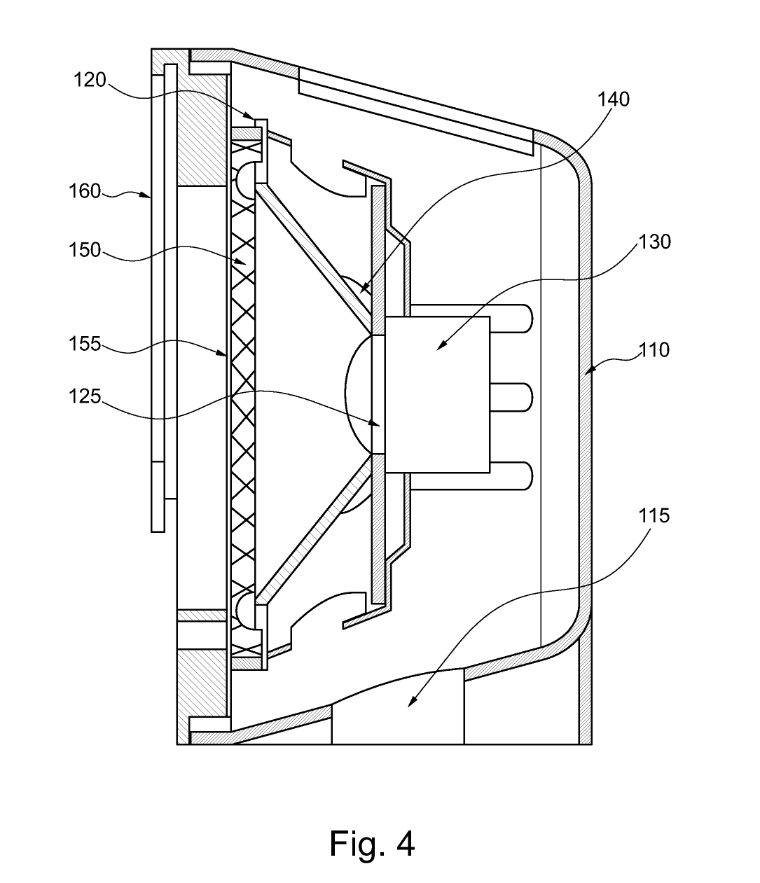

FIG. 4 is a section view of a microphone assembly 100 comprising a speaker cover 110, voids 112 in the speaker cover, a magnet 130, the magnet sometimes a neodymium magnet, a speaker or microphone cone 140, the cone sometimes made of hemp, a speaker or microphone frame 120, a voice coil 125 and spider, a foam spacer 150, a mesh screen 155 and a slide bracket. The use of foam spacer has been shown to improve the quality of captured sound.

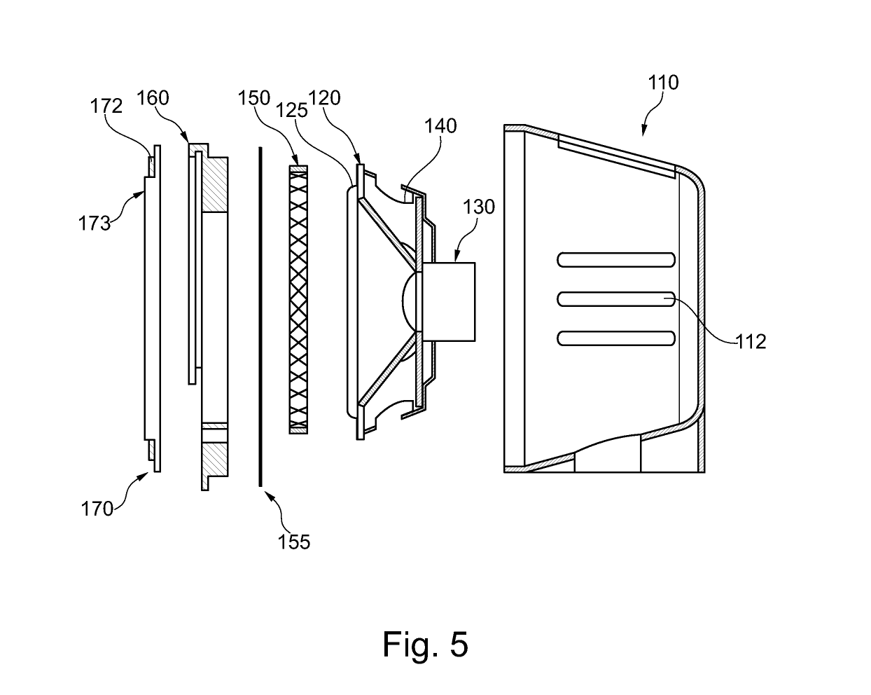

FIG. 5 shows an expanded or exploded view of a microphone assembly 100 comprising a speaker cover 110, voids 112 in the speaker cover, a magnet 130, the magnet sometimes a neodymium magnet, a speaker or microphone cone 140, the cone sometimes made of hemp, a speaker or microphone frame 120, a voice coil 125 and spider, a foam spacer 150, a mesh screen 155 and a slide bracket 160. Next to the slide bracket an attachment ring 170 is shown with a foam member 172 and an O ring.

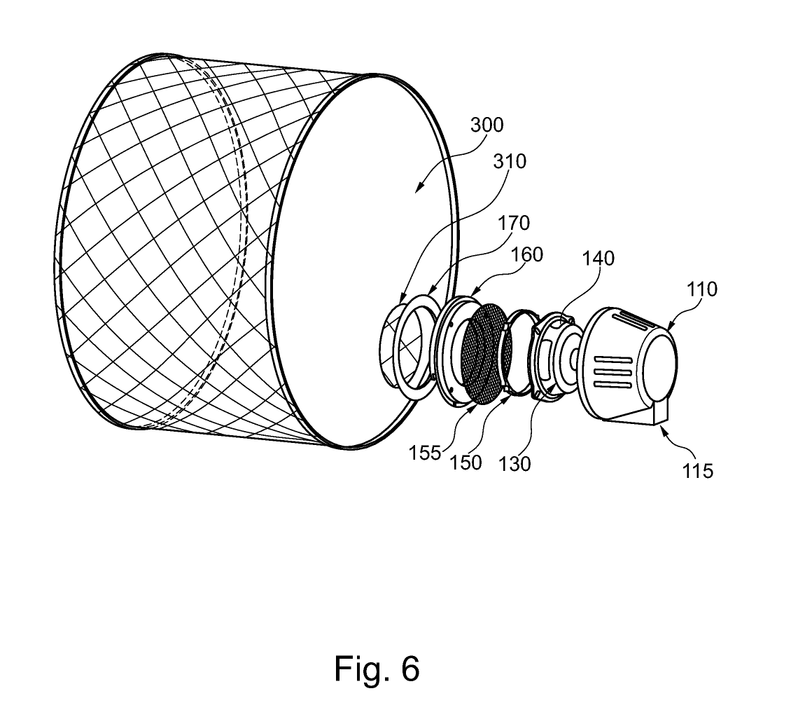

FIG. 6 depicts a drum having a drum head 300 or resonant membrane having a void 310. A foam member 172 may be attached to the drum head by use of adhesive and the foam member may be attached to an attachment ring 170. A slide bracket 160 may slide over the attachment ring, with the attachment ring securing the slide bracket 160 to the drum head 300. The slide bracket 160 may have attachment voids 163 allowing fasteners to attach the slide bracket to the speaker or microphone cover. Sandwiched between the slide bracket 160 and the speaker cover 115 is the mesh screen, foam spacer 150, magnet 130, speaker cone and speaker frame.

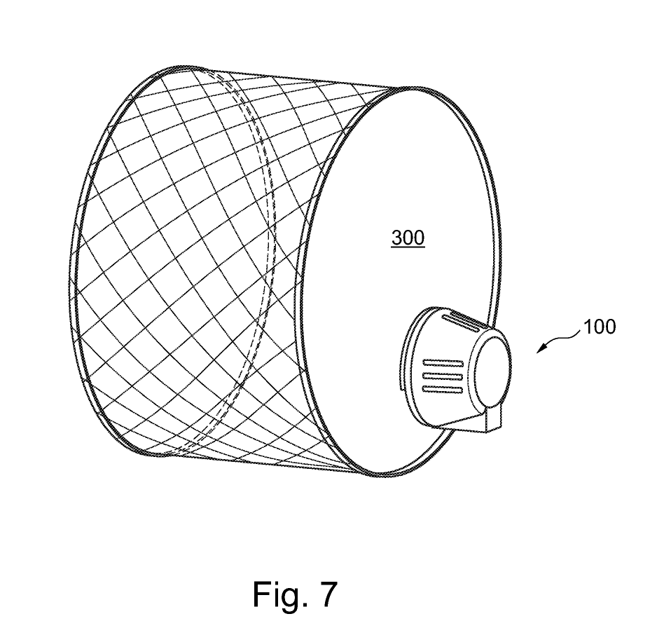

FIG. 7 depicts a microphone assembly 100 attached to a drum head 300. FIG. 7 shows the disclosed microphone assembly 100 to be an efficient attachment to the drum, in stark contrast to the prior art where complicated and awkward support members are used.

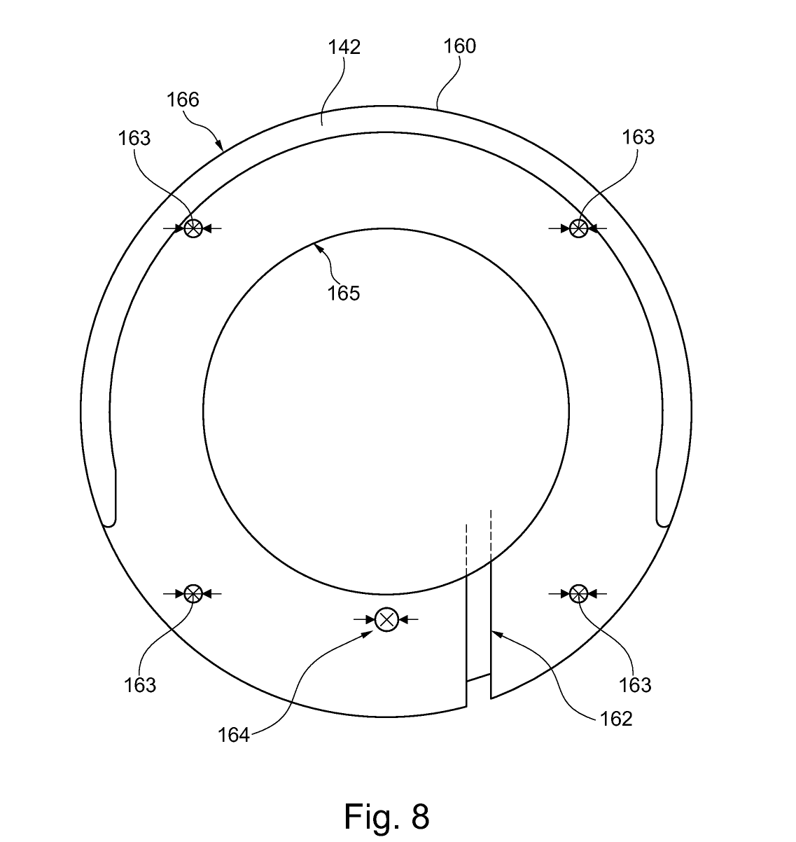

FIG. 8 depicts a face of the slide bracket 160 that faces the drum head or void in the drum. The slide bracket is shown with a channel 162 sometimes used with a XLR cable. The slide bracket 160 is also shown with a plurality of attachment voids 163. The slide bracket is also shown with a void 164 used to retain a goose neck microphone attachment. The slide bracket has an outer circumference 166 and inner circumference 165. The top wall 142 of the slide bracket is shown over the channel 162 void.

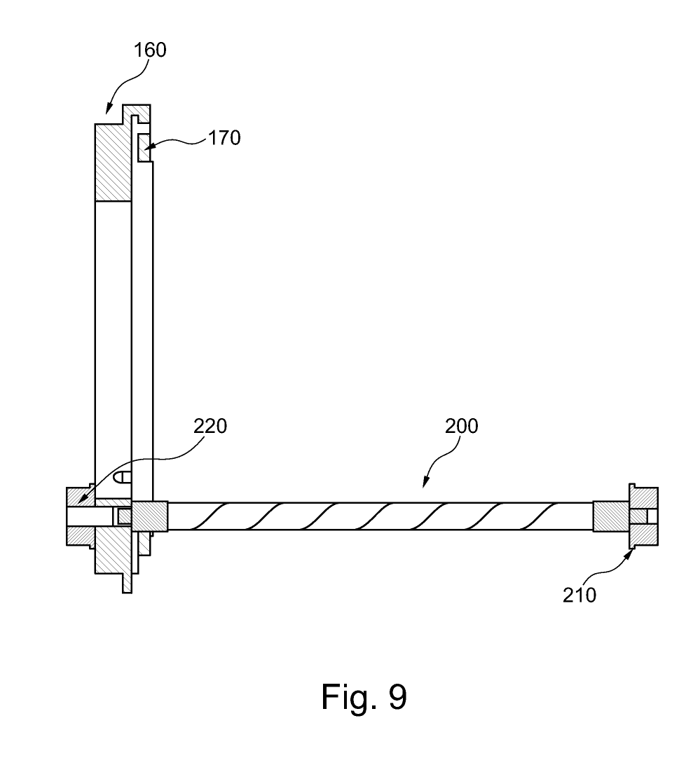

FIG. 9 depicts a flexible goose neck 200 in attachment with the slide bracket via the slide bracket's void 164 just adjacent to the channel 162. For the interior of a drum or other instrument the goose neck extends inwardly and is capped with a microphone clip 210 adapter having a female to male configuration.

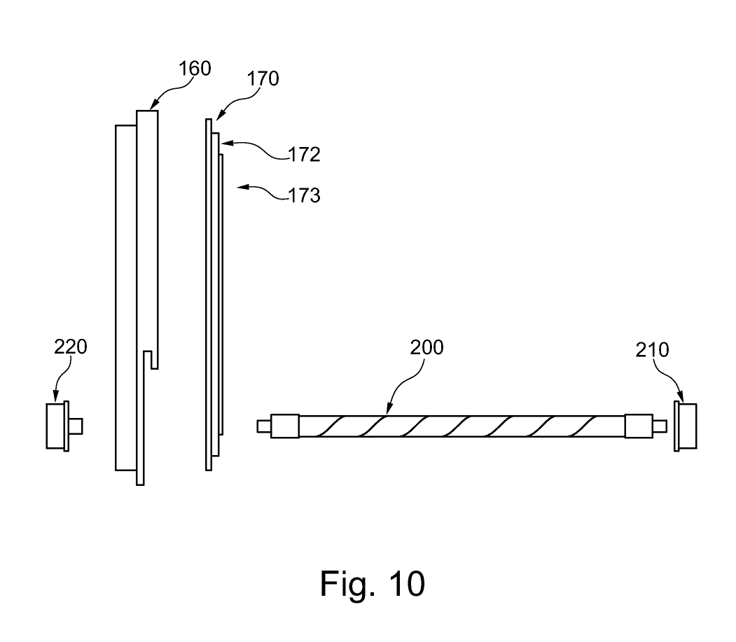

FIG. 10 is an exploded depiction of FIG. 9 and points out the attachment ring, foam member 172 and O ring 173

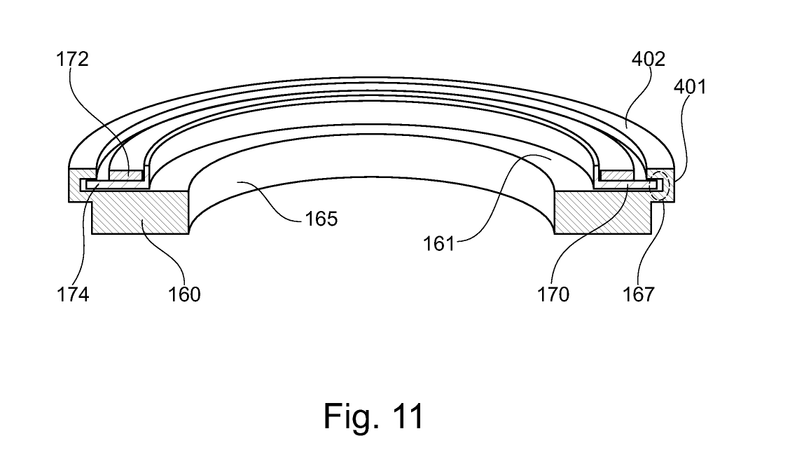

FIG. 11 depicts a slide bracket 160 mated to an attachment ring 170 with the attachment ring secured to a foam member 172. The attachment ring protrudes into a containment pocket 167 of the slide bracket. The attachment ring rests upon a shelf 161 of the slide bracket. The slide bracket is shown with a top wall 402 and a vertical outer wall 401. In general, the foam member 172 is glued or otherwise attached to a drum head and the attachment ring. The foam properties of the foam member help to increase the quality of recorded or captured sound. The attachment ring is shown with a insertion portion 174 that attaches within the containment pocket 167.

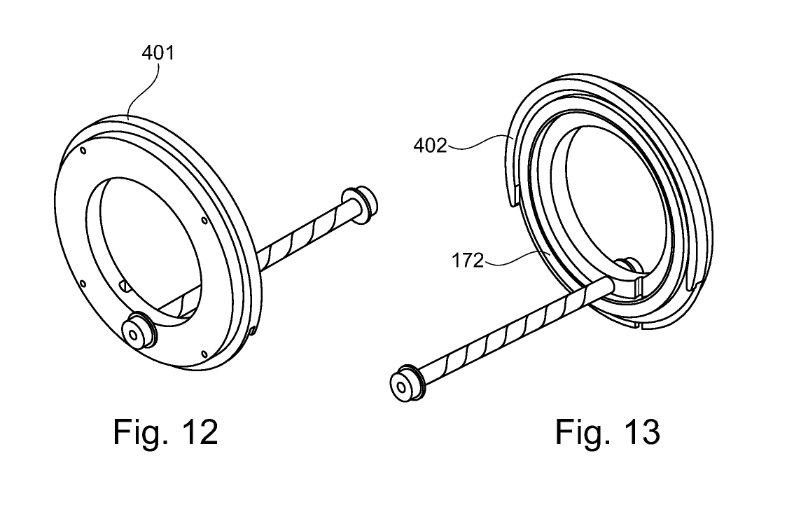

FIG. 12 depicts a front view of a slide ring with a microphone goose with the microphone goose in position to extend into a drum. Both ends of the microphone goose 200 are shown with microphone clips. FIG. 13 presents a back view of FIG. 12.

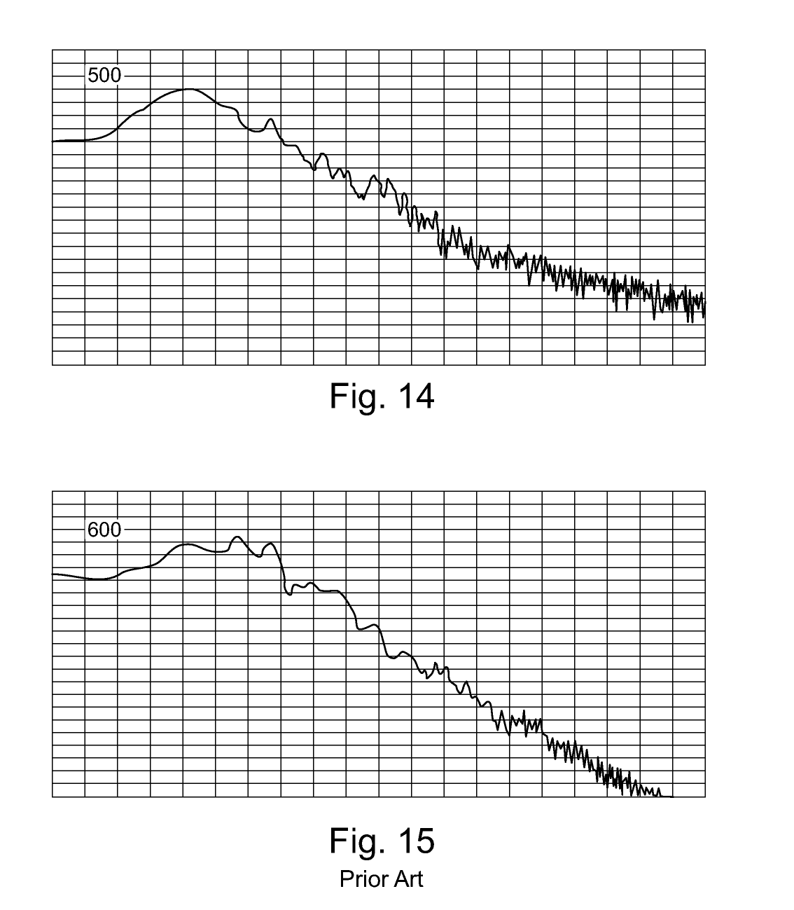

FIG. 14 presents a sound graph showing the superior sound capture of the disclosed embodiments. The sound graph of FIG. 14 was obtained with a 22 inch bass drum equipped with a disclosed microphone assembly. A very smooth frequency response was obtained in the range of 47 Hz.

FIG. 15 presents the inferior sound capture qualities of the prior art. The same 22 inch bass drum was used and the frequency response was uneven, a common shortfall in the prior art.

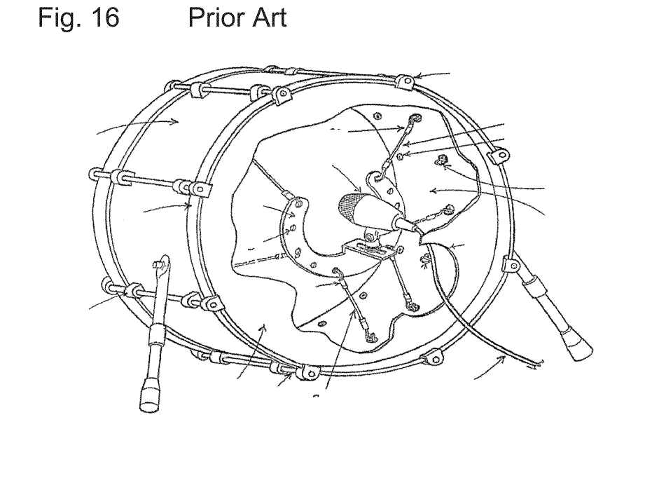

FIG. 16 presents a prior art microphone method of the Kelly patent discussed above. The complexity and inefficiency of the Kelly system has many faults, including the need to add extra voids into a drum head.

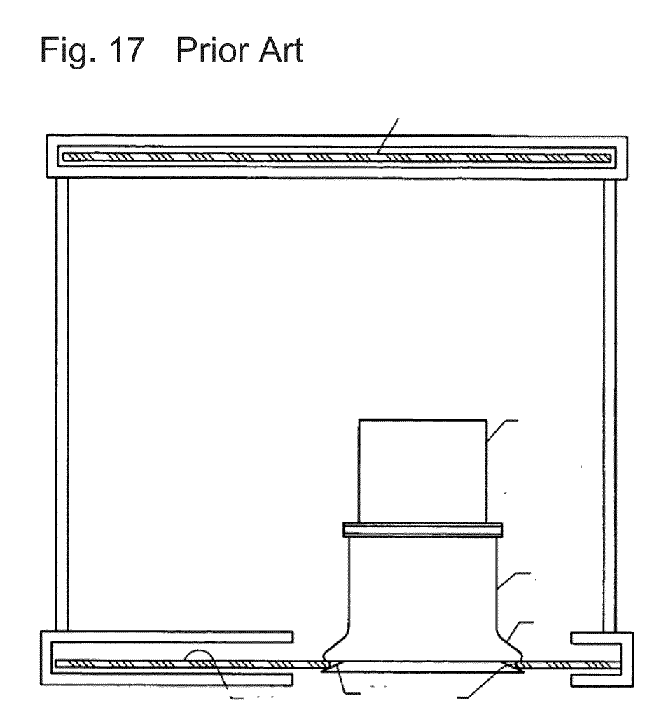

FIG. 17 depicts an insert sound chamber attached to a drum head. The system by Millender et all may be helpful in shaping the sound of a bass drum, but does not enable the artful attachment of microphones. The presently disclosed embodiments have been configured to attach to the Millender system and other KickPort type inserts.

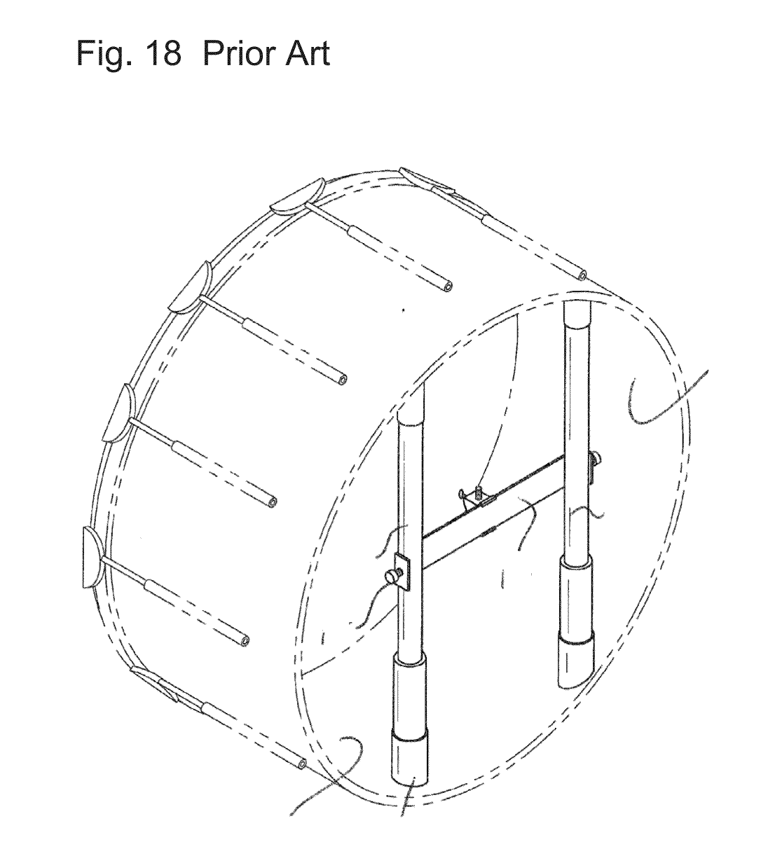

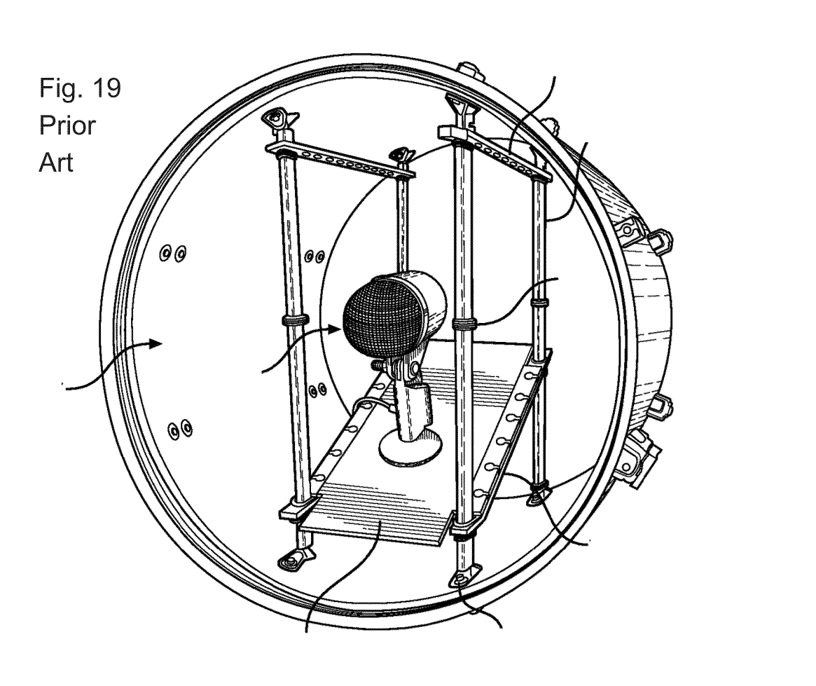

FIG. 18 depicts a support bar system disclosed in the Wells patent. The bulk of the Wells system is known to distort or otherwise change the tonal qualities of base drums.

FIG. 19 depicts a trampoline type support structure disclosed in the Mollick patent discussed above.

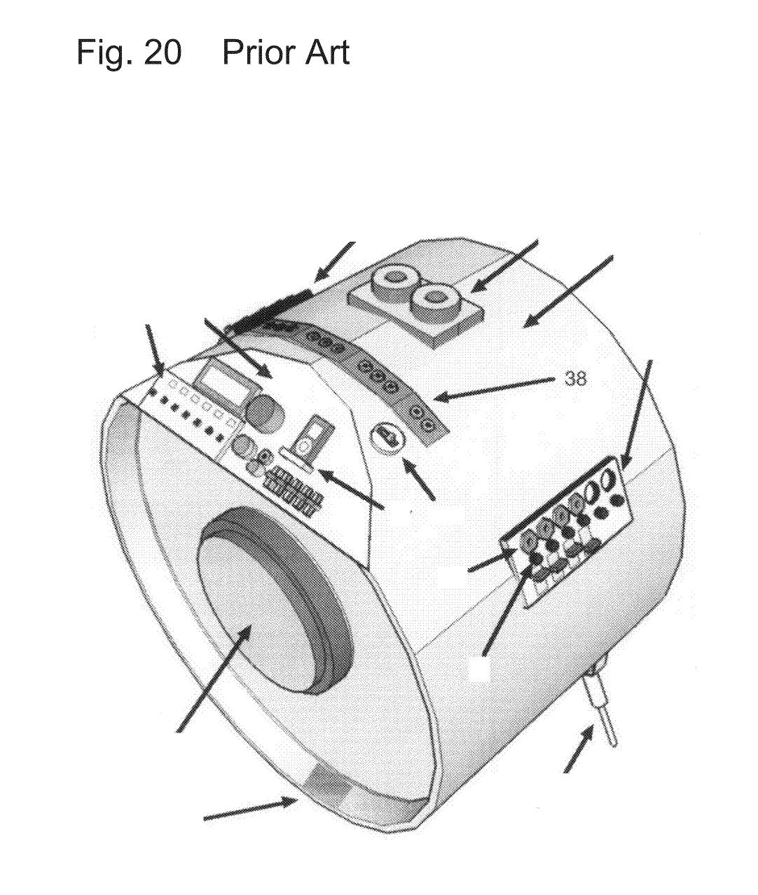

FIG. 20 depicts an electric bass drum system disclosed in the Steele patent discussed above.

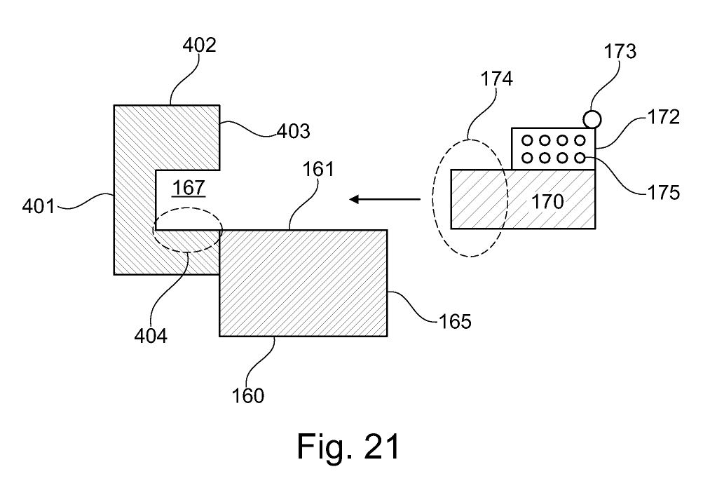

FIG. 21 depicts further embodiments of a shelf bracket 160, attachment ring 170 and foam member 172. On the right hand side, an attachment ring 170 is shown in secured to a foam member 172. The top side 176 of the foam member is sometimes glued or otherwise attached to a drum head. The attachment ring is shown with an outer perimeter side not attached to the foam member. This area is an insertion portion 174 of the attachment ring. The insertion portion 174 may be used to mate into the containment pocket 167 of the slide bracket. A directional arrow shows the insertion portion moving toward the containment pocket.

The slide bracket 160 may comprise a inner circumference wall 165, a shelf 161, a containment pocket 167, the containment pocket defined by a inner floor 404 vertical outer wall 401, top wall 402 and top face 403.

An O ring 173 may be used in a variety of positions.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

Disclosed embodiments also include the following items

Item 1. A microphone system comprising:

a) a foam member 172 having a bottom surface, the bottom surface in attachment to an upper surface of an attachment ring 170, the attachment ring having sufficient width such that a portion of upper surface of the attachment ring is without the foam member, the section of the attachment ring without the foam member referred to as an insertion portion 174 of the attachment ring;

b) a slide bracket comprising an inner circumference wall 165, a shelf 161, the shelf comprising an inner floor area 404, the inner floor area attached to a vertical outer wall, the vertical outer wall attached to a top wall and the top wall attached to a top face 403.

Item 2. The system of item 1 further comprising a containment pocket defined by the inner floor area 404, vertical outer wall, the top wall and the top face.

Item 3. The system of item 1 wherein the slide bracket defines a void 164 suitable to accept a flexible goose neck 200.

Item 4. The system of Item 3 with a flexible goose neck 200 mated into the void 164.

Item 5. The system of item 4 with the flexible goose neck having a first end attached to a microphone clip and a second end attached to a microphone clip.

Item 6. The system of Item 1 further comprising the slide ring in attachment to a mesh screen, foam spacer, speaker frame, and speaker cover.

Item 7. The system of item 6 further comprising a speaker cone made of hemp and a neodymium magnet.

Item 8. The system of item 7 wherein the slide bracket defines a channel void 162.

Item 9. The system of item 8 wherein the speaker cover defines a plurality of voids 112.

Item 10. A microphone kit comprising:

a) microphone assembly 100 comprising a speaker cover, a speaker frame, a speaker voice coil, spider, a magnet, a speaker cone, a foam spacer 150, a slide bracket 160, an attachment ring 170, and a foam member 172.

Item 11. The kit of item 10 further comprising a flexible goose neck 200 and a microphone clip.

Item 12. The kit of item 11 further comprising an O ring 173.

Item 13. The kit of item 12 wherein the slide bracket defines a channel void 162, the channel void spanning a outer circumference 166 of the slide bracket to an inner circumference 165 of the slide bracket.

Item 14. A method of microphoning a drum using a microphone assembly 100, a slide bracket 160, an attachment ring 170 and a foam member 172.

What is claimed is:

1. A microphone system comprising:
a) a foam member having a bottom surface, the bottom surface in attachment to an upper surface of an attachment ring, the attachment ring having sufficient width such that a portion of upper surface of the attachment ring is without the foam member, the section of the attachment ring without the foam member referred to as an insertion portion of the attachment ring;
b) a slide bracket comprising an inner circumference wall, a shelf, the shelf comprising an inner floor area, the inner floor area attached to a vertical outer wall, the vertical outer wall attached to a top wall and the top wall attached to a top face.

2. The system of claim 1 further comprising a containment pocket defined by the inner floor area, vertical outer wall, the top wall and the top face.

3. The system of claim 1 wherein the slide bracket defines a void suitable to accept a flexible goose neck.

4. The system of claim 3 with a flexible goose neck mated into the void of the slide bracket.

5. The system of claim 4 with the flexible goose neck having a first end attached to a first microphone clip and a second end attached to a second microphone clip.

6. The system of claim 1 further comprising the slide bracket in attachment to a mesh screen, foam spacer, speaker frame, and speaker cover.

7. The system of claim 6 further comprising a hemp speaker cone and a neodymium magnet.

8. The system of claim 7 wherein the slide bracket defines a channel void.

9. The system of claim 8 wherein the speaker cover defines a plurality of voids and wherein the foam member and foam spacer are comprised of closed cells.

10. A microphone kit comprising:
a) microphone assembly comprising a speaker cover, a speaker frame, a speaker voice coil, spider, a magnet, a speaker cone, a foam spacer, a slide bracket, an attachment ring, and a foam member.

11. The kit of claim 10 further comprising a flexible goose neck and a microphone clip.

12. The kit of claim 11 further comprising an O ring.

13. The kit of claim 12 wherein the slide bracket defines a channel void, the channel void spanning an outer circumference of the slide bracket to an inner circumference of the slide bracket and wherein the foam spacer and foam member are comprised of closed cells.

14. A method of microphoning a drum using a microphone assembly, a slide bracket, an attachment ring and a foam member.

15. The method of claim 14 including the step of using a gooseneck in attachment to the slide bracket and using a microphone clip in attachment to the gooseneck.

16. The method of claim 14 including the step of using an adhesive to secure the foam member to a drum head.

17. The method of claim 16 including the step of attaching the foam member to the attachment ring.

18. The method of claim 17 including the step of securing the slide bracket to the attachment ring.

19. The method of claim 18 including the step of attaching the slide bracket to the microphone assembly.

20. The method of claim 19 including the step of using a foam member compromised of closed cells.
